(19) United States
(12) Patent Application Publication
(10) Pub. No.: US 2008/0196237 A1
(43) Pub. Date: Aug. 21, 2008

(54) METHOD AND APPARATUS FOR MANUFACTURING HONEYCOMB COMPACT-BODY MOLDING DIE

(75) Inventors: Kiyofumi Shinya, Nishio-shi (JP); Isao Katsura, Kariya-shi (JP); Mamoru Oonishi, Takahama-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/033,099

(22) Filed: Feb. 19, 2008

(30) Foreign Application Priority Data
Feb. 21, 2007 (JP) 2007-041089

(51) Int. Cl. B21C 25/02; B23H 1/04; B23P 15/24; B26D 7/00

(52) U.S. Cl. 29/557; 29/558; 83/875; 83/51; 219/69.17; 83/563

(57) ABSTRACT

A method and apparatus for manufacturing a honeycomb compact-body molding die having material feed bores for supplying material therethrough and slit recesses formed in a polygonal lattice pattern to mold the material in a compact body with a honeycomb shape are disclosed. The slit recesses are formed on a recess forming surface of the molding die using an electrode having electrode segments, formed in a lattice pattern corresponding to shapes of the slit recesses each of which has a wall thickness of 0.1 mm or less, to generate an electrical discharge between the molding die and the electrode to form the slit recess on the molding die. When the electrode is worn by a given amount, an apical end cut-off processing step is executed to cut off an apical end of the electrode using a dress plate to expose a new apical end formed with an electrical discharge surface.

### CROSS REFERENCE TO RELATED APPLICATIONS

This application is related to Japanese Patent Application No. 2007-41089, filed on Feb. 21, 2007, the content of which is hereby incorporated by reference.

### BACKGROUND OF THE INVENTION

1. Technical Field of the Invention

The present invention relates to methods and apparatuses for manufacturing honeycomb structure-body molding dies and, more particularly, to a method and apparatus for manufacturing a honeycomb structure-body molding die for use in molding a honeycomb structure body.

2. Description of the Related Art

Honeycomb compact bodies, used for exhaust gas purifying devices of motor vehicles, have been made of, for instance, ceramics having a principal component of cordierite or the like. The honeycomb compact bodies have been manufactured by extrusion molding a material, containing ceramics raw material, using honeycomb structure-body molding dies (hereinafter suitably referred to merely as “molding dies”). Each of the honeycomb compact bodies includes a large number of cells defined with partition walls formed in a lattice pattern with a cell shape taking the form of various profiles such as a square shape and hexagonal shape, etc.

For the molding dies, molding-die main bodies have been used each in structure formed with material feed bores, through which the material is fed, and slit recesses formed under a lattice pattern in communication with the material feed bores for forming the material in a honeycomb compact body as disclosed in U.S. Pat. Nos. 6,732,621 and 5,906,839.

Methods of manufacturing such a molding die include a method of using electrical discharge processing and a method of using a grinding stone, etc.

In the related art, when forming the slit recesses using the electrical discharge processing, the electrical discharge processing has been continuously conducted until a preset depth is achieved even if an electrode is worn. However, in such a case, an apical end of the electrode becomes thin to be weak against stress applied in a lateral direction. In addition, the wearing of the electrode results in the occurrence of sidewise electrical discharge. This causes a deformation or damage to occur on the electrode, resulting in an issue with a drop in precision of the slit recesses being processed.

Further, in recent years, with a requirement for the slit recesses to be formed in finely small size with increased precision, it has been required for the electrode to have a wall thickness of 0.1 mm or less for the formation of finely small slit recesses. Moreover, in order to perform the processing at high precision, the electrical discharge processing needs to be performed in a stabilized spark discharge state with a suppressed deformation of the electrode during the electrical discharge processing.

However, with the electrode made thin, the electrode has low rigidity and is weak against lateral load, causing the electrode to be deformed when the sidewise electric discharge occurs.

### SUMMARY OF THE INVENTION

The present invention has been completed with a view to addressing the above issues and has an object to provide a method and apparatus for manufacturing a honeycomb structure-body molding die which can suppress the occurrence of deformation of an electrode during an electrical discharge processing while making it possible to process slit recesses each in a finely small size with increased precision.

To achieve the above object, the present invention provides a method of manufacturing a honeycomb compact-body molding die having material feed bores, through which a material is fed, and slit recesses formed in a polygonal lattice pattern to allow the material to pass through material feed bores for molding the material in a honeycomb compact body, the method comprising: a bore processing step of forming material feed bores in the molding die on a bore forming surface thereof; and a recess processing step of forming the slit recesses in the molding die on a recess forming surface thereof. The recess processing step includes an electrical discharge machining step, in which an electrical discharge is caused to occur between the molding die and an electrode having electrode segments, formed in a lattice pattern corresponding to shapes of the slit recesses, each of which has a wall thickness of 0.1 mm or less, and an apical end cut-off processing step to cut off an apical end of the electrode when the electrode is worn by a given amount during the electrical discharge machining step whereby the electrode has a new apical end formed with an electrical discharge surface.

It is of particular importance of the present invention that the recess processing step is performed using the electrode with a wall thickness of 0.1 mm or less with the electrical discharge machining step and apical end cut-off processing step being alternately performed under a specified condition. This allows the recess processing to be conducted in a finely form with high precision.

That is, with the method of manufacturing a honeycomb compact-body molding die, the recess processing step is conducted using a specific electrode having a lattice structure corresponding to shapes of slit recesses with an electrode segment having a wall thickness of 0.1 mm or less for forming finely small slit recesses.

With the recess processing step, the electrical discharge processing is not continuously conducted at once with the electrode placed in face-to-face relationship therewith until a desired depth is obtained for each slit recess on a final stage. As set forth above, the electrical discharge machining step and apical end cut-off processing step are alternately and repeatedly performed to progressively dig the slit recesses and, when the electrode is worn by a given amount during the electrical discharge processing, the apical end of the electrode is cut off to form a new apical electrical discharge surface.

Thus, the apical end cut-off processing step is performed in an interval between the electrical discharge machining steps at a regular interval to trim the apical electrical discharge surface of the electrode. This enables the prevention of the occurrence of sidewise electrical discharge during the electrical discharge processing, thereby making it possible to initiate an electrical discharge only at the end face of the electrode with a spark discharged kept at a fixed level. This result in a capability of performing the finely small recess processing with increased precision.

With such various steps being carried, the present invention can suppress the deformation of the electrode during the electrical discharge processing, while enabling the provision of a method of manufacturing a honeycomb compact-body molding die for enabling the processing of finely small slit recesses with increased precision.

Another aspect of the present invention provides an apparatus for manufacturing a honeycomb compact-body molding die having a bore forming surface formed with feed bores, through which a material is fed, and a recess forming surface available to be formed with slit recesses in a polygonal lattice pattern to allow the material to pass through material feed bores for molding the material in a honeycomb compact body, the apparatus comprising: a bath filled with a processing liquid; an electrical discharge head disposed over a surface of the processing liquid in the bath; an electrode carried by the electrical discharge head so as to face the recess forming surface of the molding die and having electrode segments, formed in a lattice pattern corresponding to shapes of the slit recesses, each of which has a wall thickness of 0.1 mm or less; a dress plate placed in the bath in the vicinity of the molding die and having a dress surface; an electric power supply for supplying electric power to the molding die, the electrode and the dress plate for thereby causing a first electrical discharge between the molding die and the electrode and a second electrical discharge between the molding die and the dress plate; and a transfer device mounted on the electrical discharge head and operative to move the electrode toward the electrode to initiate the first electrical discharge between the molding die and the electrode for forming the slit recesses on the slit recess forming surface of the electrode in the polygonal lattice pattern during an electrical discharge processing step. The transfer device is operative to move the electrode relative to the dress plate when the electrode is worn by a given amount for causing the second electrical discharge to occur between the molding die and the dress plate to cut off an apical end of the electrode to allow the electrode to have a new apical end formed with a new electrical discharge surface during an apical end cut-off processing step.

### BRIEF DESCRIPTION OF THE DRAWINGS

FIG. 1 is a perspective view showing a honeycomb compact-body molding die of one embodiment according to the present invention.

FIG. 2 is a top view of the honeycomb compact-body molding die as viewed in a direction shown by an arrow in FIG. 1.

FIG. 3 is a cross-sectional view of the honeycomb compact-body molding die of the embodiment shown in FIG. 1.

FIG. 4 is a perspective view showing a molding die for the honeycomb compact-body molding die of the embodiment shown in FIG. 1.

FIGS. 5A and 5B are views illustrating how a recess processing step is carried out to form the honeycomb compact-body molding die of the embodiment shown in FIG. 1.

FIG. 6 is a fragmentary enlarged view showing an electrode for use in manufacturing the honeycomb compact-body molding die of the embodiment shown in FIG. 1.

FIGS. 7A to 7D are views illustrating how an apical end cut-off processing step is carried out to trim an apical end of the electrode for use in manufacturing the honeycomb compact-body molding die of the embodiment shown in FIG. 1.

### DETAILED DESCRIPTION OF PREFERRED EMBODIMENTS

Now, a method and apparatus for manufacturing a honeycomb compact-body molding die of one embodiment according to the present invention will be described below in detail with reference to the accompanying drawings. However, the present invention is construed not to be limited to such an embodiment described below and technical concepts of the present invention may be implemented in combination with other known technologies or the other technology having functions equivalent to such known technologies.

In the following description, like reference characters designate like or corresponding component parts throughout the several views. Also the following description, it is to be understood that such terms as “cylindrical”, “apical”, “upper”, “upward”, “downward”, “sideways”, “rectangular”, “outer”, “polygonal”, “rightward” and the like are words of convenience and are not to be construed as limiting terms.

### Embodiment

With the method of manufacturing a honeycomb compact-body molding die according to the present invention, as set forth above, the recess processing step is conducted using an electrode having electrode segments, formed in a lattice structure corresponding to the shapes of the slit recesses, each of which has a wall thickness of 0.1 mm or less.

With the electrode segments each having the wall thickness exceeding 0.1 mm, it becomes difficult to form the slit recesses in finely small sizes suited for a specified application to a honeycomb compact-body molding die.

Further, the electrode has an apical electrical discharge surface that is parallel to the recess forming surface of the molding die.

Furthermore, the electrode may be preferably made of raw material such as copper tungsten (CuW).

Further, in the method of manufacturing a honeycomb compact-body molding die, an electrical discharge machining step and apical end cut-off processing step are alternately executed on repeated cycles for progressively dig the slit recesses. During the electrical discharge machining step, the electrode is placed in face-to-face relationship with the molding die with an electrical discharge occurring between the electrode and molding die to form the lit recesses. Upon wearing of the electrode at an apical electric discharge end by a given amount, the apical end cut-off processing step is executed to cut off the apical end of the electrode to expose a new electrical discharge surface.

In the electrical discharge machining step, the electrode is placed in processing liquid in face-to-face relationship with the molding die to initiate a spark discharge between the electrode and the molding die, thereby processing the molding die such that an electrode profile of the electrode is transferred onto the molding die.

The apical end cut-off processing step is conducted for the purpose of cutting off the apical end of the electrode to expose a new apical electrical discharge surface. Examples of such a step may include, for instance, a method of using a dress plate and a method of using a wire-discharge processing step, etc.

With the method of manufacturing a honeycomb compact-body molding die, the apical end cut-off processing step may be preferably performed upon cutting off the apical end of the electrode by a length of 0.2 mm or more each time the electrical discharge processing is executed to process the electrode in a processing depth with a reference depth of 0.5 mm or less.

In this case, the electrical discharge processing can be performed with a spark discharged state maintained at a fixed level in a particularly and favorable manner.

The apical end cut-off processing step may be preferably conducted before the apical end of the electrode wears by a value of 0.2 mm or more for the purpose of preventing the deformation of the electrode. To this end, it is preferable for a reference depth to be set to a value of 0.5 mm or less to cut out the apical end of the electrode each time the electrical discharge processing is conducted to the reference depth.

If the reference depth is set to a value exceeding 0.5 mm, the apical end of the electrode is greatly worn with the occurrence of sidewise electrical discharge. This results in a fear of the apical end becoming thin to be weakened against stress acting in a sidewise direction. This results in a fear of a deterioration occurring in precision of processing the slit recesses.

If the reference depth is set to a value less than 0.2 mm, the worn portion of the electrode can not be sufficiently cut off and, when conducting the electrical discharge processing again on a subsequent step, the deformation occurs on the electrode, causing a fear of a difficulty occurring to form the slit recesses with increased precision.

For the apical end cut-off processing step, if the electrode has a thickness less than 0.065 mm, it is preferable for the reference depth to be set to a value of 0.4 mm so as to allow the apical end of the electrode to be cut by a value of 0.25 mm each time the electrical discharge processing is proceeded by the reference depth of 0.4 mm.

If the electrode has a thickness ranging from 0.065 mm or more to 0.1 mm or less, it is preferable for the reference depth to be set to a value of 0.5 mm so as to allow the apical end of the electrode to be cut by a value of 0.25 mm each time the electrical discharge processing is proceeded by the reference depth of 0.5 mm.

In addition, such concrete references may be further optimized upon repeated experiments for each of sizes of the electrodes.

In the method of manufacturing a honeycomb compact-body molding die, the apical end cut-off processing step may preferably include preparing a dress plate placed for enabling the apical end cut-off processing step, placing the electrode in face-to-face relationship with a dress surface of the dress plate, and moving the electrode along the dress surface of the dress plate relative to each other while generating an electrical discharge between the electrode and the dress plate for thereby cutting off the apical end of the electrode.

In such a case, further, the apical end cut-off processing step may be conducted in a processing liquid. In addition, the dress plate may preferably include a plate made of copper tungsten (CuW).

In the method of manufacturing a honeycomb compact-body molding die, the dress plate may be preferably placed in an electrical discharge processing apparatus for performing the electrical discharge processing of the molding die, wherein the electrode remains held intact on a head upon which the electrical discharge machining step and the apical end cut-off processing step are alternately implemented.

In this case, the electrical discharge machining step and the apical end cut-off processing step can be performed in consecutive steps, enabling the recess-processing step to be efficiently performed. Moreover, no error occurs due to steps of mounting and dismounting the electrode, providing further improved precision in processing the slit recesses.

Further, in the method of manufacturing a honeycomb compact-body molding die, the apical end cut-off processing step may be preferably performed by placing a sidewall of the apical end of the electrode to be cut off in face-to-face relationship with a dress sidewall of the dress plate, and moving the electrode nearly in parallel to the dress surface relative to the dress plate while generating the electrical discharge between the apical end of the electrode and the dress sidewall of the dress plate.

In such a case, the apical end cut-off processing step can be implemented in an efficient manner.

In conducting the apical end cut-off processing step, the sidewall of the end portion is placed in face-to-face relationship with the dress sidewall under which the electrical discharge is caused to occur. This causes the end portion to be gradually worn in an area facing the dress sidewall. In consecutive step, an electrical discharge is further caused to occur between the sidewall of the end portion and the dress sidewall, thereby newly forming an apical electrical discharge surface on the electrode.

Further, the dress plate is also worn due to the presence of the electrical discharge. In this case, the dress plate is worn at an increasing rate on one side initiating the apical end cut-off processing step and the amount of wearing progressively lessened with an increase in distance from the initiating side.

Further, although the apical end cut-off processing step has a lower efficiency than that achieved using the dress plate, the apical end cut-off processing step may be preferably performed upon wire-electric discharge processing.

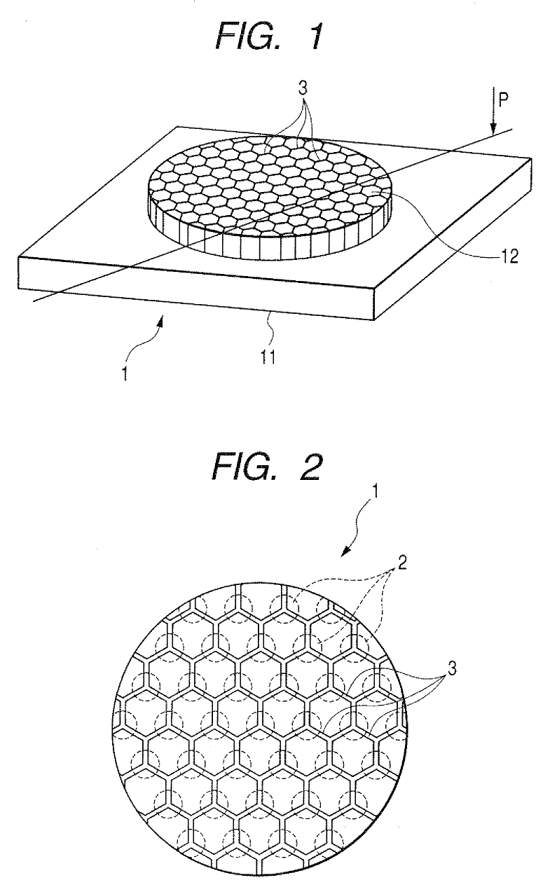

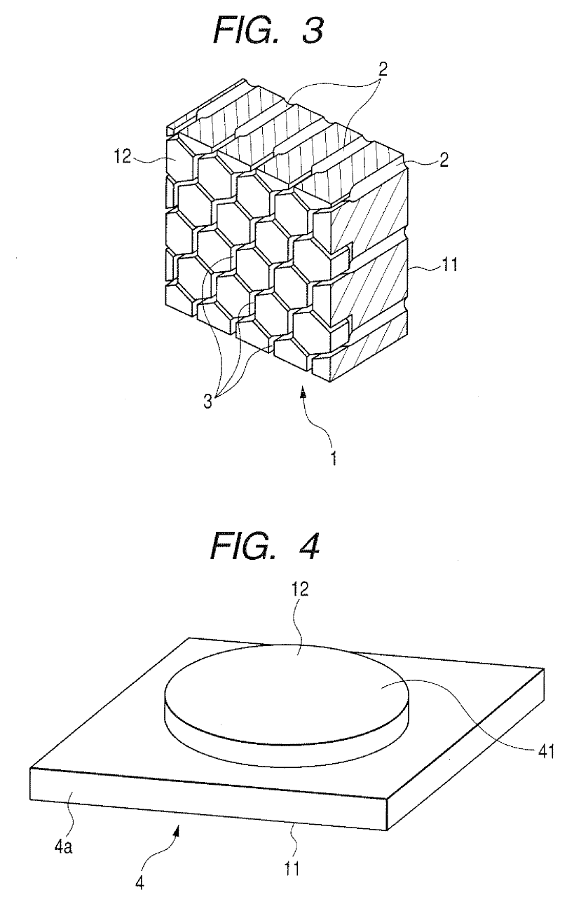

A method of manufacturing a molding die for a honeycomb compact body of an embodiment according to the present invention will be described below with reference to FIGS. 1 to 7.

As shown in FIGS. 1 to 3, the manufacturing method of the present embodiment manufactures a honeycomb compact-body molding die 1 (hereinafter suitably referred to as a “molding die 1”) that has material feed bores 2 for feeding a material therethough, and slit recesses 3 formed in a polygonal lattice pattern in communication with material feed bores 2 to mold the material into a honeycomb compact body.

The manufacturing method includes a bore machining step of machining a molding die 4 on a bore forming surface 11 thereof to form the material feed bores 2 therein at equidistantly placed positions, and a recess processing step of forming the slit recesses 3 through the molding die 4 on a slit-recess forming surface 12 thereof in opposition to the bore forming surface 11 of the molding die 4.

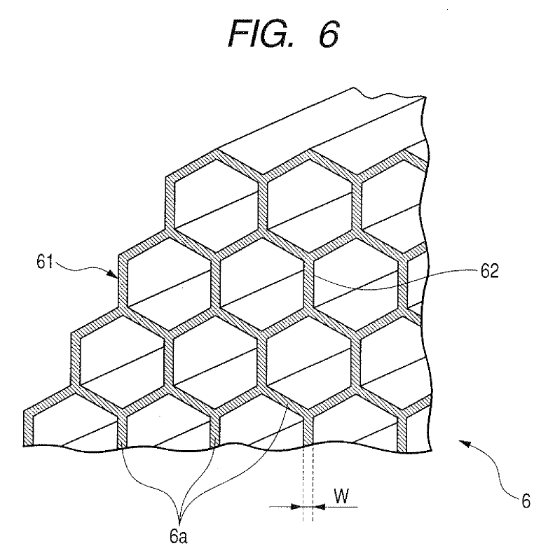

The recess processing step is executed by using an electrode 6 (see FIG. 6) having a plurality of lattice-shaped electrode segments 6a, corresponding to the slit recesses 3 in shape, each of which has a wall thickness of 0.1 mm or less. That is, in performing the recess processing step, an electrical discharge machining step and an apical end cut-off processing step are alternately executed on repeated cycles to progressively dig the slit recesses 3. The electrical discharge machining step causes an electrical discharge to occur between the molding die 1 and the electrode 6 held in face-to-face relationship therewith. The apical end cut-off processing step is executed for cutting off an apical end 61 of the electrode 6 by a given distance from a bottom end that has been worn at a given rate during the preceding electrical discharge machining step, thereby forming a new apical electrical discharge surface 62.

Hereunder, such a process will be described below in further detail.

For manufacturing the honeycomb compact-body molding die, a molding die 4, made of SKD61 (Alloy Tool Steel), was prepared as a raw material of the honeycomb compact-body molding die 1 as shown in FIG. 4. The molding die 4 had one side formed with a bore forming surface 11 in which feed bores are formed and the other side formed with a recess forming surface 12 in which slit recesses are formed. The molding die 4 had a base body 4 and a slit processing section 41, protruding upward from the base body 4a. The slit processing section 41 was formed in advance upon conducting a grinding process.

Then, in the bore machining step discussed above, the bore forming surface 11 of the molding die 4 was formed with the material feed bores 2 using a drill so as to extend from the bore forming surface 11 toward the recess forming surface 12 each in a depth not to extend through the molding die 4 and a bore diameter R ranging from φ0.7 to 1.3 mm.

Thereafter, in the recess processing step described above, the slit recesses 3 were formed on the slit processing section 41 in areas opposed to the bore forming surface 11 in fluid communication with the material feed bores 2, respectively, in a hexagonal lattice pattern each with a recess width ranging from 0.08 to 0.16±0.01 mm with a recess depth “h” ranging from 2 to 3 mm.

The recess processing step is further described below in detail.

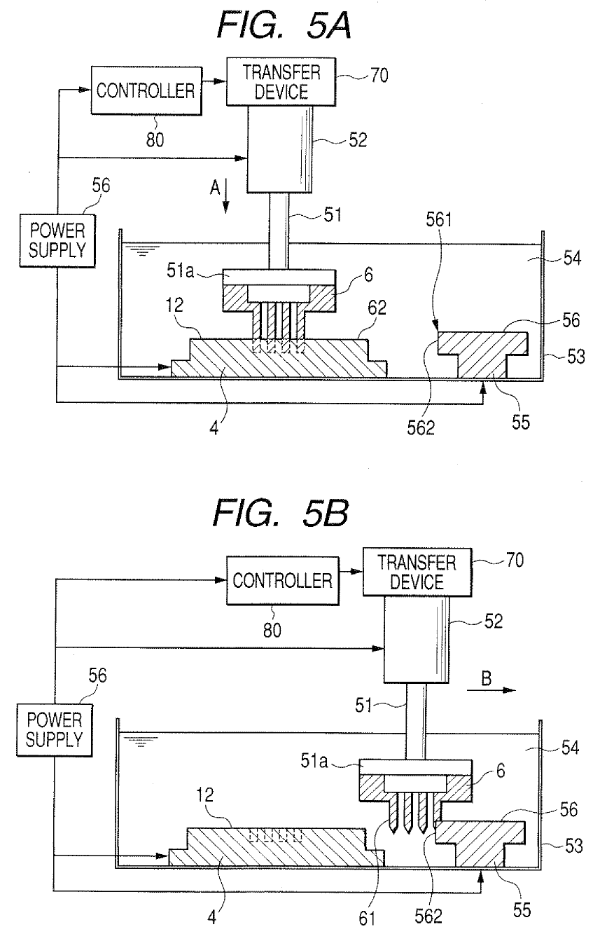

For the recess processing step, the electrical discharge machining step and the apical end cut-off processing step are alternately executed using an electric discharge processing apparatus 100, shown in FIGS. 5A and 5B, which serves as an apparatus for manufacturing the honeycomb compact-body molding die 1 (see FIG. 1).

As shown in FIGS. 5A and 5B, the electric discharge processing apparatus 100 includes a bath 53 filled with a processing liquid to which the molding die 4 and a dress plate 55 are mounted in a dipped state, an electric discharge head 52 having an electrode mount jig 51 formed with a carrier base 51a carrying thereon the electrode 6, an electric power supply 56 connected to the electric discharge head 52 and the molding die 4 and dress plate 55, a transfer device 70 operative to alternately place the electric discharge head 52 in an electrical discharge machining position, shown in FIG. 5A, and an apical end cut-off processing position shown in FIG. 513, and a controller 80 supplied with electric power from the power supply 56 and electrically connected to the transfer device 70.

The controller 80 is operative to controllably move the electric discharge head 52 downward in a direction as indicated by an arrow A in FIG. 5A to allow the electrode 6 to face with the recess forming surface 12 of the molding die 4 to form the slit recesses during the electrical discharge machining step while controllably moving the electric discharge head 52 transverse in a direction as indicated by an arrow B in FIG. 5B to allow the apical end 61 of the electrode 6 to face the dress sidewall 562 of the dress plate 55 for thereby cutting off the apical end 61 of the electrode to newly expose an apical electrical discharge surface during the apical end cut-off processing step.

The molding die 4 is dipped in the processing liquid 54 with the recess forming surface 12 placed upward for the slit recesses to be formed thereon by electrical discharge processing.

The dress plate 55 is located in the same bath 53 as that of the molding die 4 with a dress surface 56 placed upward for cutting the apical end 61 of the electrode 6 on a regular basis.

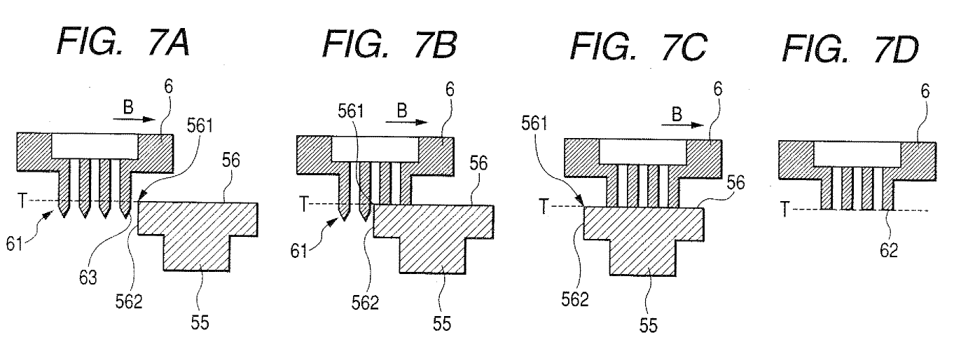

As shown in FIGS. 5A and 5B and FIGS. 7A to 7D, the dress plate 55 has a dress sidewall 562 extending downward from the dress surface 56 at an origin of a corner 561 thereof.

More particularly, the dress plate 55 takes the form of a rectangular solid body having an upper surface serving as the dress surface 56 and sidewalls one of which serves as the sidewall 562. The dress plate 55 has a width of 70 mm greater than an outer diameter of the electrode 6 and a height ranging from 5 to 25 mm with a length of 200 mm. With the dress plate having the length of 200 mm in the illustrated embodiment, the apical end cut-off processing step can be implemented more than approximately one hundred times.

Further, the electric discharge head 52, holding the electrode 6, is of a movable type that can be shifted in vertical and horizontal directions with an action of the transfer device 70.

For the electrode 6, the electrode 6, shown in FIG. 6, is used which has the apical end 61, formed in the hexagonal lattice pattern corresponding to the shape of the slit recesses to be formed with a thickness “w” laying in a value of 55 μm.

Moreover, the electrode 6 and dress plate 55 are made of the same material such as copper tungsten (CuW).

In the recess processing step, the electrical discharge processing is carried out as shown in FIG. 5A.

Under a situation where the apical electric discharge surface 62 of the electrode 6 is placed in face-to-face relationship with the recess forming surface 12 of the molding die 4 in the processing liquid 54, a voltage is applied across the electrode 6 and the molding die 4 to cause an electrical discharge to occur between the electrode 6 and the molding die 4. In this case, the controller 80 commands the transfer device 70 to cause the electric discharge head 52 to move the electrode 6 downward in the direction as shown by the arrow A. This allows the slit recesses 3 to be formed on the recess forming surface 12 of the molding die 4 such that the hexagonal lattice pattern of the distal end of the electrode 6 is transferred onto the recess forming surface 12 of the molding die 4.

If the electrode 6 is continuously used performing electrical discharge processing, the electrode 6 is caused to wear in a given amount. When this takes place, the apical electric discharge surface 62 of the electrode 6 is subjected to the apical end cut-off processing step in manners as shown in FIG. 5B and FIGS. 7A to 7D.

In the illustrated example, a reference depth was set to a value of 0.4 mm and the processing was carried out to cut off the apical end 61 of the electrode 6 by a height of 0.25 mm each time the electrical discharging executed by a value of 0.4 mm.

FIG. 7A shows the positional relationship between the electrode 6 worn in the given amount and the dress plate 55; FIGS. 7B and 7C show the electrode 6 and the dress plate 55 placed in operation to perform the apical end cut-off processing step; and FIG. 7D shows the electrode 6 formed with a new apical electrical discharge surface 62 resulting from the apical end cut-off processing step.

As shown in FIG. 5B, the molding die 4 and the dress plate 55 are located in the same bath 53. Therefore, with the electrode 6 mounted intact on the same electrical discharge head 52 as that for executing the electrical discharge machining step, the controller 80 is able to output a command to the transfer device 70 to merely move the electrical discharge head 52 sideways as shown by the arrow B in FIG. 5B. This simply enables the apical end cut-off processing step to be performed.

More particularly, first as shown in FIG. 7A, in performing the apical end cut-off processing step, the electrode 6 is moved sideways with a cut-off plane T of the electrode 6 for a new apical electrical discharge surface 62 to be exposed in the apical end cut-off processing step being held in alignment with the dress surface 56 of the dress plate 55 in the nearly same height. When this takes place, a sidewall 63 of the apical end 61 of the electrode 6 and the dress sidewall 562 of the dress plate 55 are placed in face-to-face relationship with each other. Thereafter, as shown in FIGS. 7B and 7C, an electrical discharge is caused to occur between the sidewall 63 of the apical end 61 and the dress sidewall 562. In this moment, the controller 80 actuates the transfer device 70 to move the electrical discharge head 52 for causing the electrode 6 and the dress sidewall 56 to move relative to each other in the direction as indicted by the arrow B in parallel to the dress surface 56. This progressively cuts off the apical end 61 of the electrode 6, thereby trimming the apical electrical discharge surface of the apical end 61 with the electrical discharge being caused to occur between the apical end 61 of the electrode 6 and the dress surface 56. This allows the electrode 6 to have a new apical electric discharge surface 62 exposed as shown in FIG. 7D.

The electrical discharge machining step and apical end cut-off processing step are alternately executed on repeated cycles to progressively dig the slit recesses 3 until the same reach a given depth, thereby obtaining the honeycomb compact-body molding die 1 with the structure shown in FIG. 1.

This suppresses the deformation of the electrode 6 during the electrical discharge machining step, thereby enabling the production of the honeycomb compact-body molding die 1 formed with the fine slit recesses 3 with high precision.

While the present embodiment has been described with reference to the slit recesses formed in the hexagonal lattice pattern, the molding die 4 may be formed even with the slit recesses in other polygonal lattice pattern with a consequence of the effects as those of the hexagonal lattice pattern.

In the illustrated embodiment, further, while the apical end cut-off processing step has been performed upon fusing the electrode using the dress plate, it is of course possible to perform the apical end cut-off processing step with the use of a wire-electric discharge processing.

In the illustrated embodiment, furthermore, the sidewall 63 of the apical end 61 to be cut off from the electrode 6 is placed in face-to-face relationship with the dress sidewall 562 of the dress plate 55 and the apical end cut-off processing step is performed by moving the electrode 6 and the dress surface 62 relative to each other in nearly parallel to each other. However, the apical end cut-off processing step may be possibly carried out by moving the electrode 6 and the dress surface 62 relative to each other in a vertical direction or by combining the parallel movement and vertical movement of the relevant component parts.

In the illustrated embodiment, moreover, while the apical end cut-off processing step is performed upon initiating electrical discharging between the dress plate 55 and the electrode 6, the apical end cut-off processing step may be performed by a wire-electric discharge processing apparatus (not shown) that is separately prepared. In this case, it becomes possible for the molding die 1 to have improved quality. However, such a method results in a lower efficiency than that of the method employing the dress plate 55.

While the specific embodiment of the present invention has been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof.

What is claimed is:

1. A method of manufacturing a honeycomb compact-body molding die having material feed bores, through which a material is fed, and slit recesses formed in a polygonal lattice pattern to allow the material to pass through material feed bores for molding the material in a honeycomb compact body, the method comprising:
a bore machining step of forming material feed bores in the molding die on a bore forming surface thereof; and
a recess processing step of forming the slit recesses in the molding die on a recess forming surface thereof;
wherein the recess processing step includes an electrical discharge machining step, in which an electrical discharge is generated between the molding die and an electrode having electrode segments, formed in a lattice pattern corresponding to shapes of the slit recesses, each of which has a wall thickness of 0.1 mm or less, and an apical end cut-off processing step to cut off an apical end of the electrode when the electrode is worn by a given amount during the electrical discharge processing step whereby the electrode has a new apical end formed with an electrical discharge surface.

2. The method of manufacturing a honeycomb compact-body molding die according to claim 1, wherein:
the apical end cut-off processing step is performed upon cutting off the apical end of the electrode by a length of 0.2 mm or more each time the electrical discharge processing is executed to process the electrode in a processing depth with a reference depth of 0.5 mm or less.

3. The method of manufacturing a honeycomb compact-body molding die according to claim 1, wherein:
the apical end cut-off processing step includes preparing a dress plate placed for enabling the apical end cut-off processing step, placing the electrode in face-o-face relationship with a dress surface of the dress plate, and moving the electrode along the dress surface of the dress plate relative to each other while generating an electrical discharge between the electrode and the dress plate for thereby cutting off the apical end of the electrode.

4. The method of manufacturing a honeycomb compact-body molding die according to claim 3, wherein:
the dress plate is placed in an electrical discharge processing apparatus for performing the electrical discharge processing of the molding die;
wherein the electrode remains held intact on a head upon which the electrical discharge processing step and the apical end cut-off processing step, are alternately implemented.

5. The method of manufacturing a honeycomb compact-body molding die according to claim 3, wherein:
the apical end cut-off processing step is performed by placing a sidewall of the apical end of the electrode to be cut off in face-to-face relationship with a dress sidewall of the dress plate, and moving the electrode nearly in parallel to the dress surface relative to the dress plate while generating the electrical discharge between the apical end of the electrode and the dress sidewall of the dress plate.

6. The method of manufacturing a honeycomb compact-body molding die according to claim 1, wherein:
the apical end cut-off processing step is performed by wire-electric discharge processing.

7. An apparatus for manufacturing a honeycomb compact-body molding die having a bore forming surface formed with feed bores, through which a material is fed, and a recess forming surface available to be formed with slit recesses in a polygonal lattice pattern to allow the material to pass through material feed bores for molding the material in a honeycomb compact body, the apparatus comprising:
a bath filled with a processing liquid;
an electrical discharge head disposed over a surface of the processing liquid in the bath;
an electrode carried by the electrical discharge head so as to face the recess forming surface of the molding die and having electrode segments, formed in a lattice pattern corresponding to shapes of the slit recesses, each of which has a wall thickness of 0.1 mm or less;
a dress plate placed in the bath in the vicinity of the molding die and having a dress surface;
an electric power supply for supplying electric power to the molding die, the electrode and the dress plate for thereby causing a first electrical discharge between the molding die and the electrode and a second electrical discharge between the molding die and the dress plate; and
a transfer device mounted on the electrical discharge head and operative to move the electrode toward the electrode to initiate the first electrical discharge between the molding die and the electrode for forming the slit recesses on the slit recess forming surface of the electrode in the polygonal lattice pattern during an electrical discharge processing step;
wherein the transfer device is operative to move the electrode relative to the dress plate when the electrode is worn by a given amount for causing the second electrical discharge to occur between the molding die and the dress plate to cut off an apical end of the electrode to allow the electrode to have a new apical end formed with a new electrical discharge surface during an apical end cut-off processing step.

8. The apparatus for manufacturing a honeycomb compact-body molding die according to claim 7, wherein:
the transfer device transfers the electrode toward the dress plate for cutting off the apical end of the electrode by a length of 0.2 mm or more each time the electrode segments of the electrode processes the slit forming surface in a processing depth with a reference depth of 0.5 mm or less.

9. The apparatus for manufacturing a honeycomb compact-body molding die according to claim 7, wherein:
the dress plate has a dress sidewall;
wherein the electrode is moved toward the dress plate such that the apical end of the electrode is placed in face-to-face relationship with the dress sidewall of the dress plate to generate the second electrical discharge for thereby cutting off the apical end of the electrode.

10. The apparatus for manufacturing a honeycomb compact-body molding die according to claim 9, wherein:
the electrode remains held intact on the electrical discharge head and the transfer plate alternately moves the electrode toward the molding die and the dress plate.

11. The apparatus for manufacturing a honeycomb compact-body molding die according to claim 9, wherein:
the dress plate has a dress sidewall suspended from the dress surface of the dress plate at a corner thereof;
wherein the electrode is moved relative to the dress sidewall of the dress plate in nearly parallel to the dress surface thereof such that a sidewall of the apical end of the electrode is placed in face-to-face relationship with the dress sidewall of the dress plate while generating the second electrical discharge between the apical end of the electrode and the dress sidewall of the dress plate to cut off the apical end of the electrode.
